(19) United States
(12) Patent Application Publication
(10) Pub. No.: US 2014/0313108 A1
(43) Pub. Date: Oct. 23, 2014

(54) SCAN DRIVER AND ORGANIC LIGHT EMITTING DISPLAY DEVICE INCLUDING THE SAME

(71) Applicant: SAMSUNG DISPLAY CO., LTD., Yongin-City (KR)

(72) Inventors: Do-Ik Kim, Yongin-City (KR); Baek-Woon Lee, Ulsan (KR)

(73) Assignee: SAMSUNG DISPLAY CO., LTD., Yongin-City (KR)

(21) Appl. No.: 14/229,764

(22) Filed: Mar. 28, 2014

(30) Foreign Application Priority Data
Apr. 17, 2013 (KR) 10-2013-0042353

(51) Int. Cl. G09G 3/32

(52) U.S. Cl. CPC G09G 3/3266; G09G 2310/08; G09G 2310/0291
USPC 345/76

(57) ABSTRACT

A scan driver including a plurality of scan driving circuit units for outputting scan signals and a buffer unit for receiving a control signal input to a first scan driving circuit unit of the plurality of scan driving circuit units to output the received control signal to a second scan driving circuit unit of the plurality of scan driving circuit units.

### CROSS-REFERENCE TO RELATED APPLICATION

This application claims priority to and the benefit of Korean Patent Application No. 10-2013-0042353, filed on Apr. 17, 2013, in the Korean Intellectual Property Office, the entire contents of which are incorporated herein by reference in their entirety.

### BACKGROUND

1. Field

An embodiment of the present invention relates to a scan driver and an organic light emitting display device including the same.

2. Description of the Related Art

Various flat panel displays (FPD) capable of reducing weight and volume, which are disadvantages of cathode ray tubes (CRT), have been developed. The FPDs include liquid crystal displays (LCD), field emission displays (FED), plasma display panels (PDP), and organic light emitting display devices.

Among the FPDs, the organic light emitting display devices display images using organic light emitting diodes (OLED) that generate light by re-combination of electrons and holes. The organic light emitting display device has a high response speed and is driven with low power consumption.

### SUMMARY

A scan driver according to an embodiment of the present invention includes a plurality of scan driving circuit units configured to output scan signals; and a buffer unit configured to receive a control signal to a first scan driving circuit unit of the plurality of scan driving circuit units, and output the received control signal to a second scan driving circuit unit of the plurality of scan driving circuit units.

The control signal may include a clock signal and a synchronizing signal.

The buffer unit may include: first buffer units configured to transmit the clock signal; and second buffer units configured to transmit the synchronizing signal.

Each of the plurality of scan driving circuit units may be coupled to a plurality of scan lines.

Each of the plurality of scan driving circuit units may include: a controller configured to receive the control signal, and to output select signals to a decoder, the select signals corresponding to the control signal; and a decoder configured to output the scan signals corresponding to the select signals.

The controller may be configured to output a determined select signal of the select signals to the decoder in synchronization with the clock signal in a first period when the synchronizing signal is input.

The decoder may be configured to output the scan signals to the scan lines corresponding to the select signals.

The first buffer units and the second buffer units may be configured to convert a transmission direction of the control signal.

Each of the first buffer units and each of the second buffer units may include: a first buffer configured to transmit a signal in a first direction; and a second buffer configured to transmit the signal in a second direction.

The first buffer and the second buffer may include tri-state buffers.

The scan driving circuit units may include integrated circuits (IC).

An organic light emitting display device including: a plurality of pixels coupled to scan lines and data lines; a data driver configured to supply data signals to the data lines; and a scan driver including: a plurality of scan driving circuit units coupled to a plurality of different scan lines; and a buffer unit configured to receive a control signal to a first scan driving circuit unit of the plurality of scan driving circuit units, and to output the received control signal to a second scan driving circuit unit of the plurality of scan driving circuit units.

The organic light emitting display device may further include a timing controller configured to supply the control signal.

### BRIEF DESCRIPTION OF THE DRAWINGS

Example embodiments will now be described more fully hereinafter with reference to the accompanying drawings; however, they may be embodied in different forms and should not be construed as being limited to the embodiments set forth herein. These embodiments are described to provide a thorough and complete disclosure, and will full convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout the present disclosure.

FIG. 1 is a view illustrating an organic light emitting display device according to an embodiment of the present invention;

FIG. 2 is a view illustrating an embodiment of the pixel illustrated in FIG. 1;

FIG. 3 is a view illustrating a scan driver according to an embodiment of the present invention;

FIG. 4 is a view illustrating a scan driving circuit unit according to an embodiment of the present invention;

FIG. 5 is a waveform diagram illustrating an operation of the scan driving circuit unit illustrated in FIG. 4;

FIG. 6 is a view illustrating a scan driver according to another embodiment of the present invention; and

FIG. 7 is a view illustrating a buffer unit according to an embodiment of the present invention.

### DETAILED DESCRIPTION

Hereinafter, a scan driver according to an embodiment of the present invention and an organic light emitting display device including the same will be described with reference to various embodiments of the present invention and drawings.

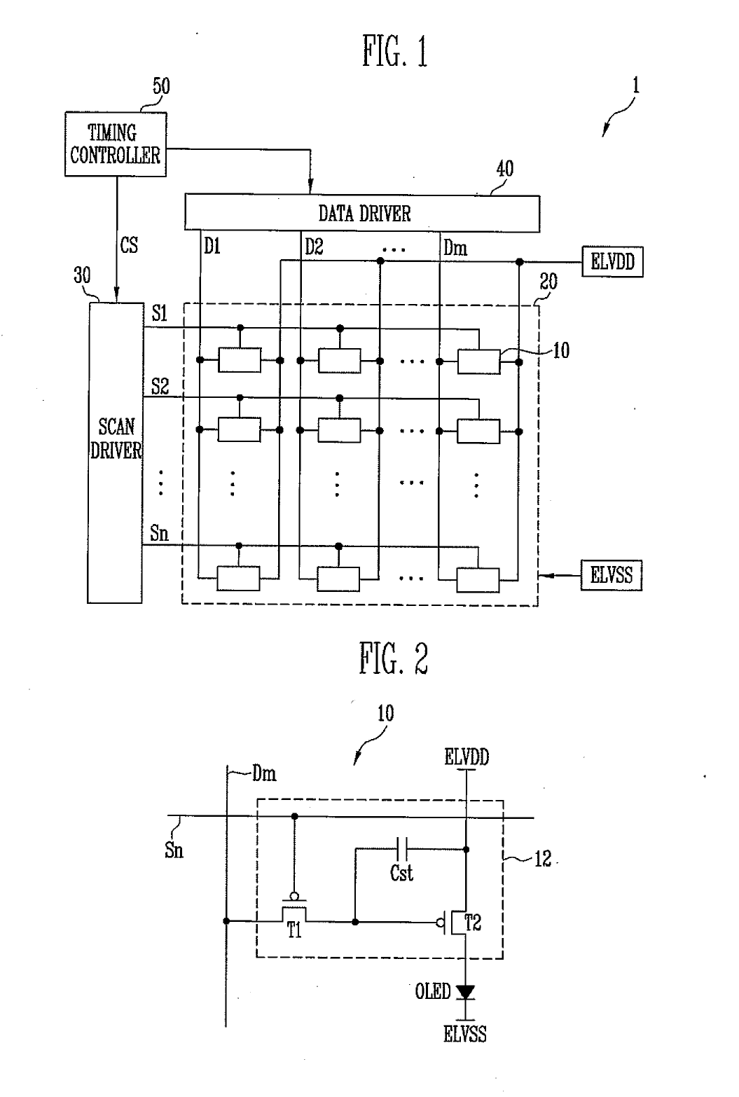

FIG. 1 is a view illustrating an organic light emitting display device according to an embodiment of the present invention.

Referring to FIG. 1, an organic light emitting display device 1 according to the embodiment of the present invention includes a pixel unit 20 including a plurality of pixels 10 coupled to scan lines S1 to Sn and data lines D1 to Dm, a scan driver 30 for supplying scan signals to the pixels 10 through the scan lines S1 to Sn, and a data driver 40 for supplying data signals to the pixels 10 through the data lines D1 to Dm.

In addition, the organic light emitting display device 1 may further include a timing controller 50 for controlling the scan driver 30 and the data driver 40.

The pixels 10 may receive a first power supply ELVDD and a second power supply ELVSS from a power supply unit.

The pixels 10 that receive the first power supply ELVDD and the second power supply ELVSS may generate light corresponding to the data signals by a current that flows from the first power supply ELVDD to the second power supply ELVSS via organic light emitting diodes (OLED).

The scan driver 30 may generate the scan signals by control from the timing controller 50, and may supply the generated scan signals to the scan lines S1 to Sn.

For example, the scan driver 30 may be driven to correspond to a control signal CS inputted from the timing controller 50.

In addition, the scan driver 30 may supply the scan signals to the scan lines in, for example, a specific order.

The data driver 40 may generate the data signals by control from the timing controller 50 and may supply the generated data signals to the data lines D1 to Dm.

When a scan signal is supplied to a particular scan line, the pixels 10 coupled to that particular scan line may receive the data signals transmitted from the data lines D1 to Dm.

The timing controller 50 may control the scan driver 30 and the data driver 40. For example, the timing controller 50 may supply the control signal CS to the scan driver 30 to control the scan driver 30.

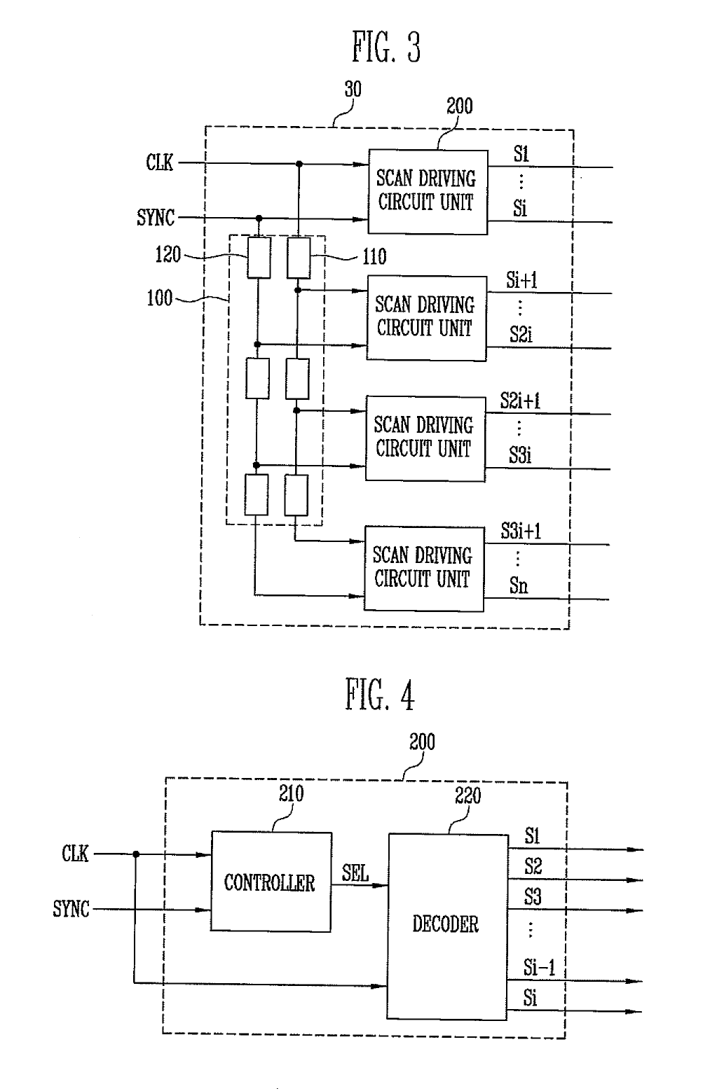

FIG. 2 is a view illustrating an embodiment of the pixel illustrated in FIG. 1. By way of example and for the sake of convenience, a pixel coupled to the nth scan line Sn and the mth data line Dm will be illustrated in FIG. 2.

Referring to FIG. 2, a pixel 10 includes an OLED and a pixel circuit 12 coupled to the data line Dm and the scan line Sn to control the OLED.

An anode electrode of the OLED may be coupled to the pixel circuit 12 and a cathode electrode of the OLED may be coupled to the second power supply ELVSS.

The OLED may generate light with a predetermined or a set brightness to correspond to a current supplied from the pixel circuit 12.

According to an embodiment, the pixel circuit 12 may control an amount of current supplied to the OLED to correspond to the data signal supplied to the data line Dm when the scan signal is supplied to the scan line Sn. Accordingly, the pixel circuit 12 includes a second transistor T2 coupled between the first power supply ELVDD and the OLED, a first transistor T1 coupled with the second transistor T2, the data line Dm, and the scan line Sn, and a storage capacitor Cst coupled between a gate electrode and a first electrode of the second transistor T2.

According to an embodiment, a gate electrode of the first transistor T1 is coupled to the scan line Sn and a first electrode of the first transistor T1 is coupled to the data line Dm. A second electrode of the first transistor T1 is coupled to one terminal of the storage capacitor Cst. In the present disclosure, the first electrode of a transistor is defined as either a source electrode or a drain electrode, and the second electrode of the transistor is defined as an electrode different from the first electrode. For example, when the first electrode is the source electrode, the second electrode is the drain electrode.

The first transistor T1 coupled to the scan line Sn and the data line Dm, is turned on when the scan signal is supplied from the scan line Sn to supply the data signal supplied from the data line Dm to the storage capacitor Cst. The storage capacitor Cst may become charged with a voltage corresponding to the data signal.

The gate electrode of the second transistor T2 is coupled to one terminal of the storage capacitor Cst, and the first electrode of the second transistor T2 is coupled to the other terminal of the storage capacitor Cst and the first power supply ELVDD. A second electrode of the second transistor T2 may be coupled to the anode electrode of the OLED.

The second transistor T2 may control an amount of current that flows from the first power supply ELVDD to the second power supply ELVSS via the OLED to correspond to the voltage stored in the storage capacitor Cst. Thus, the OLED may generate light corresponding to an amount of current supplied by the second transistor T2.

Because the above-described pixel structure of FIG. 2 is one example embodiment of the present invention, the pixel 10 of the present invention is not necessarily limited to the above pixel structure. In some embodiments, the pixel circuit 12 has a pixel structure capable of supplying current to the OLED and may have any suitable pixel structure known to those skilled in the art.

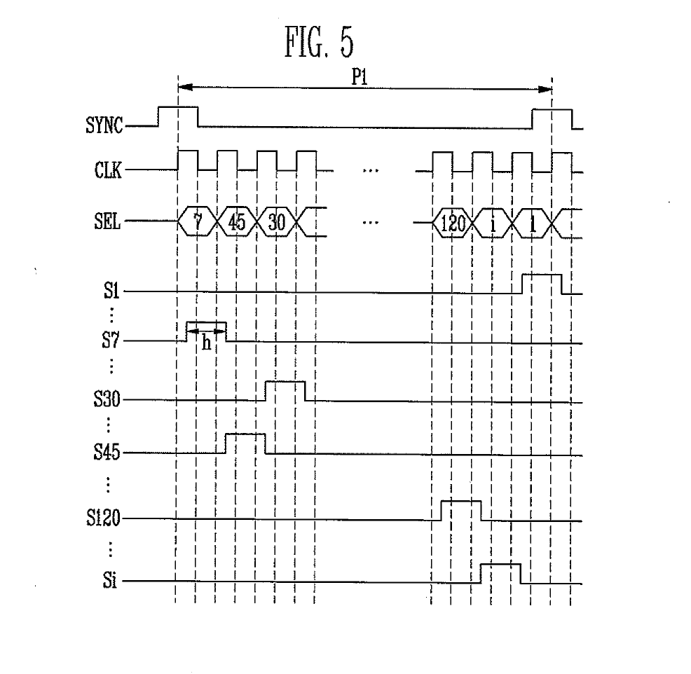

FIG. 3 is a view illustrating a scan driver according to an embodiment of the present invention.

Referring to FIG. 3, the scan driver 30 according to the embodiment of the present invention includes a buffer unit 100 and a plurality of scan driving circuit units 200.

The scan driving circuit units 200 may output the scan signals to correspond to the control signal CS input from the outside.

The control signal CS input to the scan driving circuit units 200 may include a clock signal CLK and a synchronizing signal SYNC.

The scan driving circuit units 200 may be coupled to the plurality of different scan lines.

For example, the first scan driving circuit unit 200 from an upper side of the scan driver 30 shown in FIG. 3 may be coupled to the first scan line S1 to a first scan line Si, the second scan driving circuit unit 200 (e.g., second block from the top in FIG. 3) may be coupled to an (i+1)th scan line Si+1 to a 2ith scan line S2i, the third scan driving circuit unit 200 (e.g., third block from the top in FIG. 3) may be coupled to a (2i+1)th scan line S2i+1 to a 3ith scan line S3i, and the fourth scan driving circuit unit 200 (e.g., fourth block from the top in FIG. 3) may be coupled to a (3i+1)th scan line S3i+1 to the nth scan line Sn.

According to the embodiment, the number of scan lines coupled to each of the scan driving circuit units 200 may be the same or different from each other.

The scan driving circuit units 200 may output the scan signals to the scan lines coupled thereto.

Thus, the scan driving circuit units 200 may supply the scan signals to the scan lines in a predetermined or a set order.

For example, the first scan driving circuit unit 200 from the upper side may output scan signals to the first scan line S1 to the ith scan line Si coupled thereto.

In some embodiments, the first scan driving circuit unit 200 may supply the scan signals to the scan lines in accordance with an order such as a seventh scan line S7, a 45^{th} scan line S45, a 30^{th} scan line S30, . . . , a 120^{th} scan line S120, the ith scan line Si, and the first scan line S1.

Although FIG. 3 shows four scan driving circuit units 200 in the scan driver 30, by way of example, the number of scan driving circuit units 200 may vary.

In some embodiments, the buffer unit 100 may receive the control signal CS input to a kth scan driving circuit unit 200 to input the control signal CS to a (k+1)th scan driving circuit unit 200.

That is, the control signal CS input to a previous scan driving circuit unit 200 may be supplied to a next scan driving circuit unit 200 through the buffer unit 100.

For example, the buffer unit 100 may transmit the control signal CS supplied to the first scan driving circuit unit 200 to the second scan driving circuit unit 200.

According to an embodiment, the buffer unit 100 includes first buffer units 110 for transmitting the clock signal CLK and second buffer units 120 for transmitting the synchronizing signal SYNC.

That is, the first buffer unit 110 receives the clock signal CLK inputted from the kth scan driving circuit unit 200 to supply the clock signal CLK to the (k+1)th scan driving circuit unit 200, and the second buffer unit 120 may receive the synchronizing signal SYNC input to the kth scan driving circuit unit 200 to supply the synchronizing signal SYNC to the (k+1)th scan driving circuit unit 200.

Because the clock signal CLK and the synchronizing signal SYNC are supplied to the scan driving circuit units 200 through the buffer units 110 and 120, respectively, RC delays of the signals CLK and SYNC may be minimized.

Thus, to prevent an erroneous operation from occurring by noise, the first buffer units 110 and the second buffer units 120 may be realized by, for example, Schmitt trigger buffers.

In some embodiments, the scan driving circuit units 200 may be realized by integrated circuits (IC).

In some embodiments, the first buffer units 110 and the second buffer units 120 may be realized by integrated circuits together with the scan driving circuit units 200 coupled thereto.

FIG. 4 is a view illustrating a scan driving circuit unit 200 according to an embodiment of the present invention. FIG. 5 is a waveform diagram illustrating an operation of the scan driving circuit unit 200 illustrated in FIG. 4.

For example, in FIG. 4, the scan driving circuit unit 200 coupled to the first scan line S1 to the ith scan line Si is illustrated.

Referring to FIG. 4, the scan driving circuit unit 200 according to the embodiments of the present invention may include a controller 210 and a decoder 220.

The controller 210 may receive the control signal CS supplied from the outside and may output a select signal SEL to the decoder 220 to correspond to the received control signal CS.

In some embodiments, the synchronizing signal SYNC and the clock signal CLK may be included with the control signal CS inputted to the controller 210.

For example, when the controller 210 receives the synchronizing signal SYNC, the controller 210 may output a predetermined or a set select signal SEL to the decoder 220 in synchronization with the clock signal CLK during a first period P1.

The select signal SEL supplied from the controller 210 to the decoder 220 may include information that refers to a specific scan line.

The decoder 220 may output a scan signal to correspond to the select signal SEL inputted from the controller 210.

For example, the decoder 220 may output a scan signal to a scan line corresponding to the received select signal SEL.

For example, when the select signal SEL including information that refers to the seventh scan line S7 is received, the decoder 220 outputs a scan signal to the seventh scan line S7.

Referring to FIG. 5, a detailed driving operation of the scan driving circuit unit 200 will be described.

According to an embodiment, when the synchronizing signal SYNC is inputted to the controller 210, the controller 210 may transmit a predetermined or a set select signal SEL to the decoder 220 in synchronization with the input clock signal CLK.

For example, the controller 210 may sequentially supply a plurality of select signals SEL to the decoder 220 during the first period P1.

The plurality of select signals SEL supplied to the decoder 220 in the first period P1 may correspond to different scan lines.

For example, the controller 210 may sequentially supply a select signal SEL that refers to the seventh scan line S7, a select signal SEL that refers to the 45^{th} scan line S45, a select signal SEL that refers to the 30^{th} scan line S30, . . . , a select signal SEL that refers to the 120^{th} scan line S120, a select signal SEL that refers to the ith scan line Si, and a select signal SEL that refers to the first scan line S1 to the decoder 220.

Because the decoder 220 outputs the scan signals to the scan lines corresponding to the received select signals SEL, the decoder 220 may output the scan signals in accordance with an order such as, the seventh scan line S7, the 45^{th} scan line S45, the 30^{th} scan line S30, . . . , the 120^{th} scan line S120, the ith scan line Si, and the first scan line S1.

When the scan signals are supplied during the first period P1 and the synchronizing signal SYNC is supplied again, the first period P1 may be terminated and a new first period P1 may be restarted.

In the new first period P1, the controller 210 and the decoder 220 may perform the above operation again from the beginning.

The respective scan signals may have a predetermined or a set period h, as shown in FIG. 5.

In FIG. 5, the scan signals are output to the scan lines in a non-sequential manner. However, the scan signals may be sequentially output to the first scan line S1 to the ith scan line Si by control of the controller 210.

According to an embodiment, the select signals SEL may be realized by data having a plurality of bits. For example, the select signals SEL may have values such as “111” and “101101”.

For example, the select signal SEL having the value of “111” may be used for referring to the seventh scan line S7, and the select signal SEL having the value of “101101” may be used for referring to the 45^{th} scan line S45.

A driving order of the scan lines S1 to Si may be programmed in the controller 210.

That is, in some embodiments, because the driving order of the scan lines S1 to Si is determined by the values and supply order of the select signals SEL supplied from the controller 210, the values and supply order of the select signals SEL supplied to the decoder 220 during the first period P1 may be predetermined or set by the controller 210.

Because additional control signal for controlling the driving order of the scan lines to the scan driving circuit unit 200 is not supplied, the number of wiring lines for transmitting signals is reduced, thus reducing dead space in a display device.

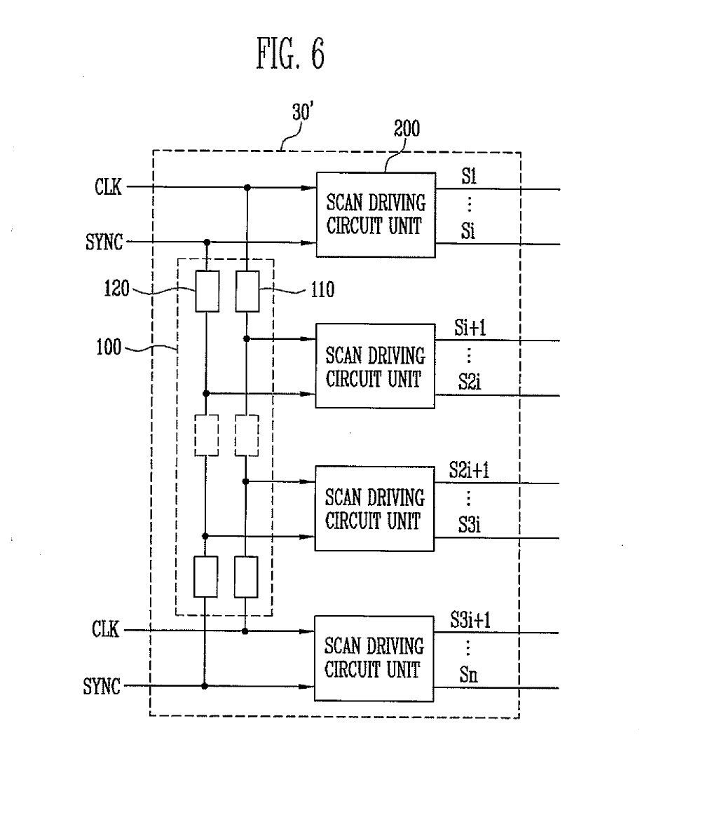

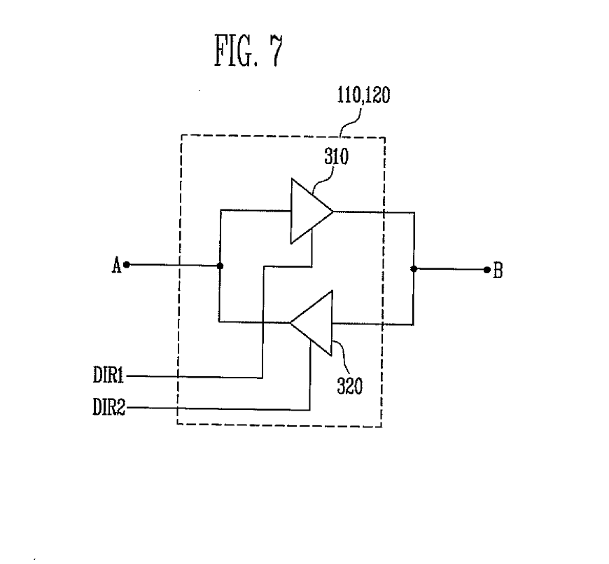

FIG. 6 is a view illustrating a scan driver 30′ according to another embodiment of the present invention. FIG. 7 is a view illustrating a buffer unit according to an embodiment of the present invention.

Referring to FIGS. 6 and 7, in the scan driver 30′ according to another embodiment of the present invention, first buffer units 110 and second buffer units 120 may convert a transmission direction of the control signal CS.

For example, the first buffer units 110 may change a transmission direction of the clock signal CLK and the second buffer units 120 may change a transmission direction of the synchronizing signal SYNC.

Accordingly, the first buffer unit 110 and the second buffer unit 120 may include a first buffer 310 for transmitting a signal in one direction and a second buffer 320 for transmitting the signal in the other direction opposite to the one direction, as shown in FIG. 7.

For example, the first buffer 310 may transmit the control signal CS from a terminal A to a terminal B, and the second buffer 320 may transmit the control signal CS from the terminal B to the terminal A.

According to the embodiment, the first buffer 310 and the second buffer 320 may be controlled by direction control signals DIR1 and DIR2.

The direction control signals DIR1 and DIR2 may be supplied by the timing controller 50.

In some embodiments, the first buffer 310 and the second buffer 320 may be tri-state buffers.

For example, when the first buffer 310 is driven as a normal buffer and the second buffer 320 is set to be in a high impedance state, the control signal CS input to the terminal A may be output to the terminal B through the first buffer 310.

In some embodiments, when the second buffer 320 is driven as a normal buffer and the first buffer 310 is set to be in a high impedance state, the control signal CS input to the terminal B may be output to the terminal A through the second buffer 320.

Accordingly, the first buffer unit 110 and the second buffer unit 120 may be driven alternatingly as normal buffers.

As described above, when the first buffer unit 110 and the second buffer unit 120 can be driven in both directions, the control signal CS may not only be supplied from one side of the scan driver 30 (as shown in FIG. 3) but may be supplied from both sides of the scan driver 30′ as illustrated in FIG. 6.

For example, the clock signal CLK and the synchronizing signal SYNC may be supplied to a first scan driving circuit unit 200 from an upper side, and also from a lower side with reference to FIG. 6.

Therefore, the clock signal CLK and the synchronizing signal SYNC supplied to the first scan driving circuit unit 200 from the upper side may be transmitted to a second driving circuit unit 200 from the upper side through the first buffer unit 110 and the second buffer unit 120.

In addition, the clock signal CLK and the synchronizing signal SYNC supplied to the first scan driving circuit unit 200 from the lower side may be transmitted to a second scan driving circuit unit 200 from the lower side through the first buffer unit 110 and the second buffer unit 120.

In this case, because the first buffer unit 110 and the second buffer unit 120 illustrated by a dotted line in FIG. 6 are not driven, the first buffer unit 110 and the second buffer unit 120 illustrated by the dotted line may be omitted.

That is, the first buffer unit 110 and the second buffer unit 120 positioned between the scan driving circuit units 200 that receive the control signal CS supplied from the upper end of the scan driver 30′, and the scan driving circuit units 200 that receive the control signal CS supplied from the lower end of the scan driver 30′ are not driven or omitted.

In summary, the display device includes the pixels arranged in a matrix, the data driver for driving the data lines coupled to the pixels, and the scan driver for driving the scan lines coupled to the pixels.

The scan driver is controlled by the control signal supplied from the outside.

However, the amount of dead space may be increased by the wiring lines for transmitting the control signal, or the RC delay is generated in the control signal such that that the scan driver may erroneously operate.

As described above, according to the embodiments of the present invention, the dead space of the organic light emitting display device can be reduced by reducing the number of wiring lines for controlling the scan driver of the organic light emitting display device.

In addition, according to the embodiments of the present invention, the scan driver reduces or minimizes the RC delay of the control signal of the organic light emitting display device.

Example embodiments have been described herein, and although specific terms are employed, they are to be interpreted in a generic and descriptive sense, and not for purposes of limitation. In some instances, the features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims and their equivalents.

What is claimed is:

1. A scan driver comprising:
a plurality of scan driving circuit units configured to output scan signals; and
a buffer unit configured to receive a control signal to a first scan driving circuit unit of the plurality of scan driving circuit units, and output the received control signal to a second scan driving circuit unit of the plurality of scan driving circuit units.

2. The scan driver as claimed in claim 1, wherein the control signal comprises a clock signal and a synchronizing signal.

3. The scan driver as claimed in claim 2, wherein the buffer unit comprises:
first buffer units configured to transmit the clock signal; and
second buffer units configured to transmit the synchronizing signal.

4. The scan driver as claimed in claim 2, wherein each of the plurality of scan driving circuit units is coupled to a plurality of scan lines.

5. The scan driver as, claimed in claim 4, wherein each of the plurality of scan driving circuit units comprises:
a controller configured to receive the control signal, and to output select signals to a decoder, the select signals corresponding to the control signal; and
a decoder configured to output the scan signals corresponding to the select signals.

6. The scan driver as claimed in claim 5, wherein the controller is configured to output a determined select signal of the select signals to the decoder in synchronization with the clock signal in a first period when the synchronizing signal is input.

7. The scan driver as claimed in claim 6, wherein the decoder is configured to output the scan signals to the scan lines corresponding to the select signals.

8. The scan driver as claimed in claim 3, wherein the first buffer units and the second buffer units are configured to convert a transmission direction of the control signal.

9. The scan driver as claimed in claim 8, wherein each of the first buffer units and each of the the second buffer units comprises:
a first buffer configured to transmit a signal in a first direction; and
a second buffer configured to transmit the signal in a second direction.

10. The scan driver as claimed in claim 9, wherein the first buffer and the second buffer comprise tri-state buffers.

11. The scan driver as claimed in claim 1, wherein the scan driving circuit units comprise integrated circuits (IC).

12. An organic light emitting display device comprising:
a plurality of pixels coupled to scan lines and data lines;
a data driver configured to supply data signals to the data lines; and
a scan driver comprising:
a plurality of scan driving circuit units coupled to a plurality of different scan lines; and
a buffer unit configured to receive a control signal to a first scan driving circuit unit of the plurality of scan driving circuit units, and to output the received control signal to a second scan driving circuit unit of the plurality of scan driving circuit units.

13. The organic light emitting display device as claimed in claim 12, wherein the control signal comprises a clock signal and a synchronizing signal.

14. The organic light emitting display device as claimed in claim 13, wherein the buffer unit comprises:
first buffer units configured to transmit the clock signal; and
second buffer units configured to transmit the synchronizing signal.

15. The organic light emitting display device as claimed in claim 12, wherein each of the plurality of scan driving circuit units comprises:
a controller configured to receive the control signal and to output select signals to a decoder, the select signals corresponding to the control signal; and
a decoder configured to output scan signals corresponding to the select signals.

16. The organic light emitting display device as claimed in claim 15, wherein the controller is configured to output a determined select signal of the select signals to the decoder in synchronization with a clock signal in a first period when a synchronizing signal is input.

17. The organic light emitting display device as claimed in claim 16, wherein the decoder is configured to output the scan signals to the scan lines corresponding to the select signals.

18. The organic light emitting display device as claimed in claim 14, wherein the first buffer units and the second buffer units are configured to convert a transmission direction of the control signal.

19. The organic light emitting display device as claimed in claim 18, wherein each of the first buffer units and each of the second buffer units comprises:
a first buffer configured to transmit a signal in a first direction; and
a second buffer configured to transmit the signal in a second direction.

20. The organic light emitting display device as claimed in claim 19, wherein the first buffer and the second buffer comprise tri-state buffers.

21. The organic light emitting display device as claimed in claim 12, wherein the scan driving circuit units comprise integrated circuits (IC).

22. The organic light emitting display device as claimed in claim 12, further comprising a timing controller configured to supply the control signal.
